(19) United States
(12) Patent Application Publication
(10) Pub. No.: US 2008/0048462 A1
(43) Pub. Date: Feb. 28, 2008

(54) Thermoplastic composite bumper system

(75) Inventor: Benjamin Roger Zabik, Ann Arbor, MI (US)

Correspondence Address: FOLEY AND LARDNER LLP;SUITE 500, 3000 K STREET NW, WASHINGTON, DC, 20007, US

(73) Assignee: Meridian Automotive System, Inc.

(21) Appl. No.: 11/882,606

(22) Filed: Aug. 2, 2007

Related U.S. Application Data
(60) Provisional application No. 60/834,880, filed on Aug. 2, 2006.

(51) Int. Cl. B60R 19/03

(52) U.S. Cl. 293/120

(57) ABSTRACT

A bumper beam for a vehicle includes an outer skin formed of a polymeric material and a core provided within the outer skin. At least a portion of the core comprises an expanded material. The bumper beam is configured for coupling to a vehicle and the outer skin and core are configured to resist deformation in a vehicle collision.

### CROSS-REFERENCE TO RELATED PATENT APPLICATIONS

This application claims the benefit of U.S. Provisional Patent Application No. 60/834,880 filed Aug. 2, 2006, the entire disclosure of which is incorporated herein by reference.

### BACKGROUND

The present invention relates generally to the field of bumpers and bumper assemblies for use with vehicles such as automobiles and the like. More particularly, the present invention relates to materials and methods of manufacturing bumper beams for such bumpers and bumper assemblies.

Bumper assemblies for vehicles such as automobiles and the like typically include a bumper beam that is connected to the frame of the vehicle, an energy absorber coupled to the bumper beam, and an outer fascia that is positioned toward the front of the vehicle. The fascia is typically a part of the exterior of the vehicle, and acts to conceal the underlying bumper beam and energy absorber.

Bumper beams are conventionally formed of a metal such as steel or aluminum, and have a generally hollow tubular cross-section. For example, the cross-section of a bumper beam may have a generally rectangular shape or may have a different shape such as a “B-shaped” cross-section that is manufactured by roll forming and sweeping a sheet of metal such that it obtains a desired cross-sectional shape. Examples of bumper beam cross-sections are illustrated in FIGS. 2 and 3, where FIG. 2 illustrates a conventional generally B-shaped bumper beam and FIG. 3 illustrates a bumper beam having a generally rectangular cross-section.

It would be advantageous to provide an improved bumper beam and/or a method of manufacturing such an improved bumper beam.

### SUMMARY

An exemplary embodiment relates to a bumper beam for a vehicle that includes an outer skin formed of a polymeric material and a core provided within the outer skin. At least a portion of the core comprises an expanded material. The bumper beam is configured for coupling to a vehicle and the outer skin and core are configured to resist deformation in a vehicle collision.

Another exemplary embodiment relates to a polymeric bumper beam for use in vehicle applications that includes a shell formed of a reinforced thermoplastic material and an interior portion comprising an expanded foam material. The bumper beam is configured for attachment to a vehicle.

Another exemplary embodiment relates to a vehicle bumper beam that includes a tubular member comprising a polymeric matrix and a reinforcing material provided within the polymeric matrix and a material provided within at least a portion of the tubular member that is configured to provide compressive strength for the bumper beam. The bumper beam is configured for attachment to a vehicle and to an energy absorber for a vehicle bumper system.

### BRIEF DESCRIPTION OF THE DRAWINGS

FIG. 1 is perspective view of a vehicle illustrating a bumper assembly according to an exemplary embodiment.

FIG. 2 is a cross-sectional view of a conventional B-shaped bumper beam according to an exemplary embodiment.

FIG. 3 is a cross-sectional view of a conventional bumper beam having a rectangular cross-section according to another exemplary embodiment.

FIG. 4A is a perspective view of a bumper system according to an exemplary embodiment.

FIG. 4B is a cross-sectional view of the bumper system shown in FIG. 4A.

FIG. 5A is a perspective view of a bumper system according to another exemplary embodiment.

FIG. 5B is a cross-sectional view of the bumper system shown in FIG. 5A.

FIG. 6 is a plan view of a mold system for manufacturing a bumper system according to an exemplary embodiment.

FIG. 7 is a perspective view of a bumper system manufactured using the system shown in FIG. 6 according to an exemplary embodiment.

FIG. 8 is a flow chart describing steps in a compression molding process according to an exemplary embodiment.

FIG. 9 is a flow chart of describing steps in a thermoforming process according to another exemplary embodiment.

FIG. 10 is a perspective view of a thermoplastic sheet comprising a plurality of layers according to an exemplary embodiment.

FIG. 11A is a top plan view of a bumper system that utilizes crush cans inserted in between the sections of the outer skin and the core piece of the bumper beam according to an exemplary embodiment.

FIG. 11B is a top plan view illustrating a member coupled between a bumper beam and the frame rails of the vehicle according to an exemplary embodiment.

FIG. 12 is a perspective view of a bumper beam illustrating using ribs to reinforce the strength of the bumper beam, according to an exemplary embodiment.

FIG. 13 is a perspective view of a bumper beam illustrating the use of a number of cylindrical reinforcing members to reinforce the strength of the bumper beam according to another exemplary embodiment.

FIG. 14 is a perspective view of a bumper beam illustrating the use of a honeycomb core to reinforce the strength of the bumper beam according to another exemplary embodiment.

FIG. 15 is a perspective view of a vehicle illustrating a composite bumper beam and energy absorber according to an exemplary embodiment.

### DETAILED DESCRIPTION

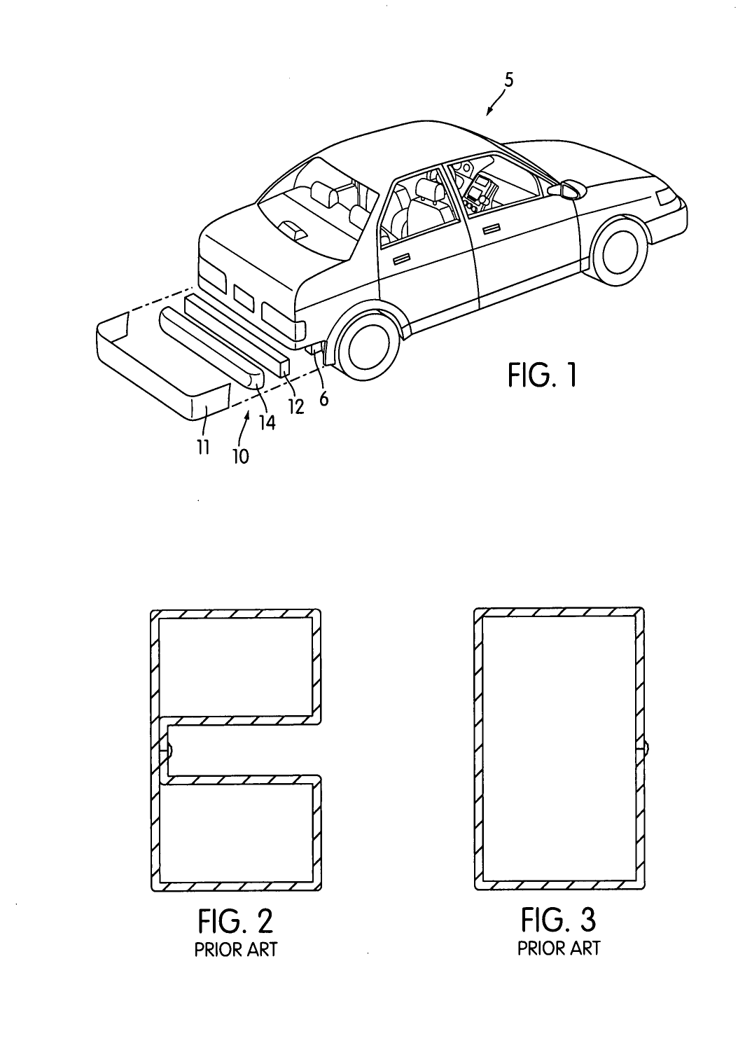

Referring to FIG. 1, a vehicle 5 (e.g., an automobile) is shown that includes a bumper system or assembly 10 according to an exemplary embodiment. The bumper system 10 includes a member or element in the form of a bumper beam 12 that is coupled to a portion of a frame 6 of the vehicle 5. A member or element in the form of an energy absorber 14 is coupled to the bumper beam 12, and a fascia or trim piece 11 is provided to substantially conceal the bumper beam 12 and the energy absorber 14 from view.

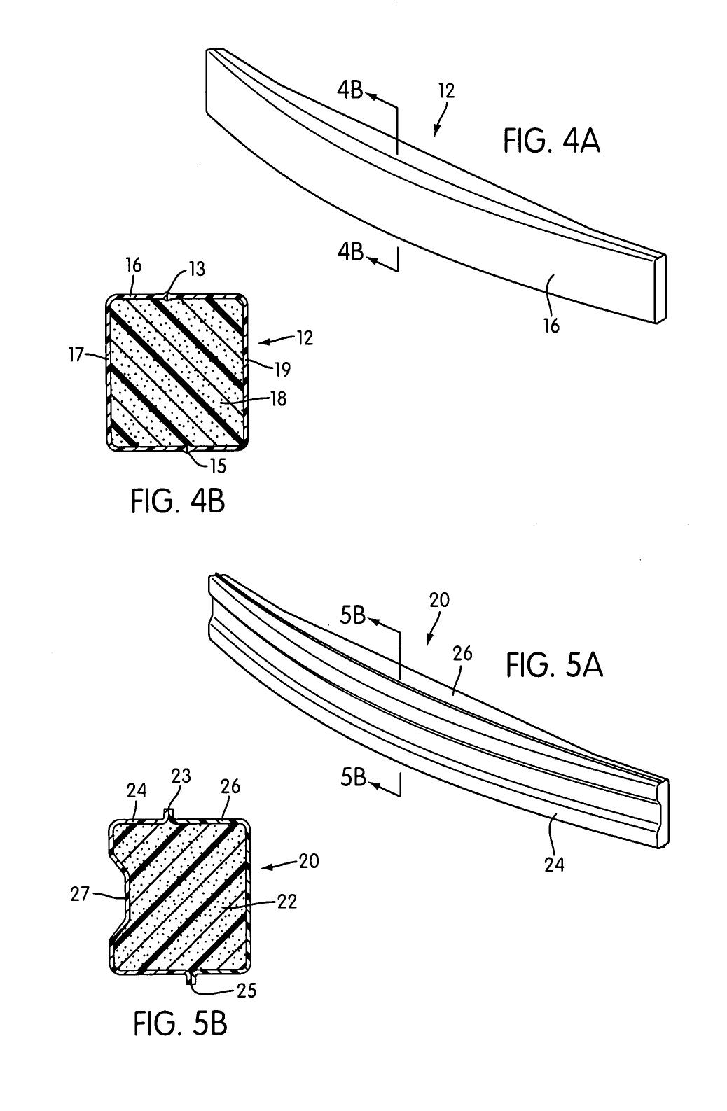

In contrast to the use of bumper beams that are formed of a generally hollow construction from steel or aluminum, according to an exemplary embodiment as shown in FIGS. 4A and 4B, the bumper beam 12 includes a inner core 18 surrounded by an outer skin or shell 16 that is formed from a thermoplastic or a thermosetting polymeric material (e.g., polypropylene, polyethylene, etc.). The polymeric skin or shell may be provided as an unreinforced polymeric material or may have reinforcing materials such as glass or carbon fibers incorporated therein for added strength and rigidity, depending on the needs for a particular application.

As shown in FIGS. 4A and 4B, the outer skin includes a first portion or section 17 that is coupled to a second portion or section 19 at points 13 and 15. Points 13 and 15 represent the locations at which sections 17 and 19 of the outer skin 16 are joined together during fabrication of the bumper beam 12 (e.g., the portions may be joined by local melting and/or compression within the mold or by using a separate step involving a laser welding operation, an adhesive, or other suitable joining methods). The first and second sections 17 and 19 may be formed from the same material or from different materials according to various exemplary embodiments.

It should be noted that while FIGS. 4A and 4B illustrate a bumper beam 12 having a generally rectangular cross-sectional shape throughout its length (although the size of the cross-section will vary due to the thickness variation along the length), it should be understood that any of a variety of cross-sectional shapes may be possible according to other exemplary embodiments. For example, as shown in FIGS. 5A and 5B, a bumper system 20 includes a core 22 surrounded by an outer skin formed from two sheets 24, 26 of thermoplastic material that are coupled together at points 23 and 25. One surface or face of the bumper beam is formed such that it includes a cutout or channel 27 formed therein. Any of a variety of other configurations, sizes, and shapes may also be possible according to other exemplary embodiments, all of which are intended to fall within the scope of the present disclosure.

The outer shell or skin 16 is formed of a thermoplastic or thermosetting polymeric material. According to an exemplary embodiment, the outer skin 16 includes a polymeric matrix that has a reinforcing material incorporated therein. For example, according to an exemplary embodiment in which the polymeric matrix comprises a polypropylene or nylon based material, a reinforcing material may be provided within the matrix to provide enhanced strength for the outer skin. The sheet can be formed into the outer skin or sections thereof by thermoforming, compression forming, or roll-forming.

Although according to one exemplary embodiment, the sections of the outer skin 16 are formed of a single sheet of polymeric material having a uniform composition throughout, as shown in FIG. 10, according to other exemplary embodiments, a thermoplastic sheet 34 may be used that includes more than one layer of thermoplastic material (e.g., a plurality of layers of polymeric material are bonded or compressed together to form a single sheet of material). Each of these sheets may then be formed into a shape so as to form a section of the outer skin of a bumper beam. Each of the layers in the sheet may have identical or different compositions. For example, according to a particular exemplary embodiment, the sheet 34 may include alternating layers of polypropylene and nylon (or any other suitable combination of two or more polymeric materials).

Exemplary thicknesses of the sheets that form the outer skin can range from 1-20 mm. According to an exemplary embodiment, the outer skin has a thickness of between approximately 2 and 7 mm. The thickness of the sheets that form the outer skin can also vary depending upon the location and the structural requirements for the outer skin at different locations on the bumper beam.

Any of a variety of reinforcing materials may be utilized according to various other exemplary embodiments for the outer skin. For example, a reinforcing material may be provided as generally continuous and unidirectional strands of materials such as glass, carbon, or nylon fibers that are oriented in any suitable direction (e.g., along the length of the bumper beam) within the polymeric matrix. According to other exemplary embodiments, the fibers may be provided as short strands that are generally randomly oriented within the polymeric matrix. According to still other exemplary embodiments, the reinforcing material may be provided as a mat of reinforcing fibers. It should also be understood that more than one type of reinforcing material may be used (e.g., a mat of glass fibers may be incorporated within the polymeric matrix along with randomly oriented short strands of carbon fibers).

According to a particular exemplary embodiment, glass fibers having an average length greater than 25 mm may be used as a reinforcement material for one or both sections of the outer skin. The relatively long glass fibers incorporated within the thermoplastic sheet is intended to provide a relatively high strength thermoplastic composite skin with superior impact performance as compared to thermosetting composites. According to other exemplary embodiments, glass fibers having a length less than 25 mm may be used in place of or in addition to the long glass fibers (either randomly oriented or in a generally unidirectional arrangement).

The inner core 18 is provided in the form of a foam material such as an expanded polypropylene, polyurethane, polystyrene, or similar materials or derivatives thereof. One advantageous feature of such a construction is that the outer skin 16 provides requisite tensile strength for the bumper beam, while the inner core 18 provides the necessary compressive strength for the bumper beam. The foam may be provided as a preformed component within a mold or may be provided such that the foam is expanded in situ during the molding of the bumper beam.

The core is intended to provide buckling stability for the outer skin, and absorbs energy in localized impacts. A high compressive strength core bonded to the high tensile strength skin provides a very robust bumper beam. The finished bumper beam is intended to provide a relatively low cost, lightweight alternative to conventional metal bumper beams.

The core materials can be any material with a very high ratio of compressive strength to mass. Typical foams would have an average compressive strength of between approximately 0.3 and 1.5 MPa. According to an exemplary embodiment, an 80 gpl foam having a compressive strength of about 1.1 MPa is used.

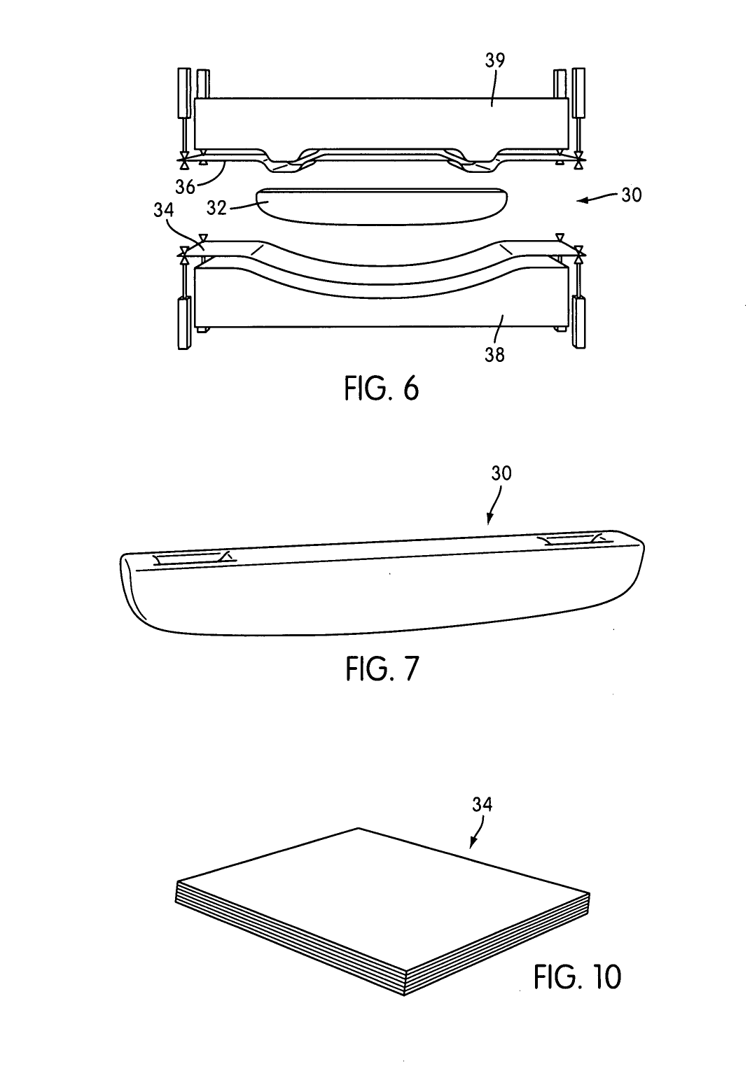

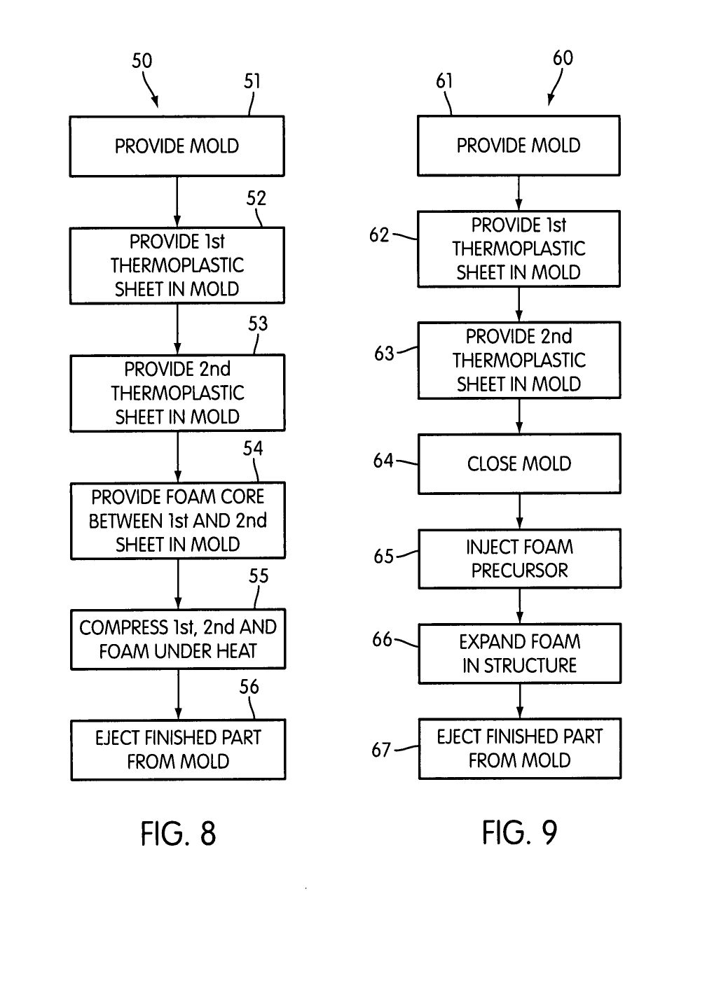

Referring to FIGS. 6-7 and 10, a manufacturing process 50 for a bumper beam is shown according to an exemplary embodiment in which a vacuum forming or compression molding process is utilized. In a first step 51, a vacuum or compression mold is provided, after which the sheets 34, 36 of thermoplastic materials which will form the sections of the outer skin 16 are placed adjacent the mold halves 38 and 39 in steps 52 and 53. The foam core 32, which has been manufactured separately using any suitable process to form a preformed shape, is then introduced between the first and second sheets 34, 36 in the mold in a step 54. In a step 55, the mold is closed to compress the sections 34 and 36 of the outer skin of the bumper beam 30 together around the foam core 32, which then bonds them together around the foam core 32 to form a bumper beam as shown in FIG. 7. The unit is then ejected from the mold in step 56 and trimmed/deflashed to form a finished bumper beam 30.

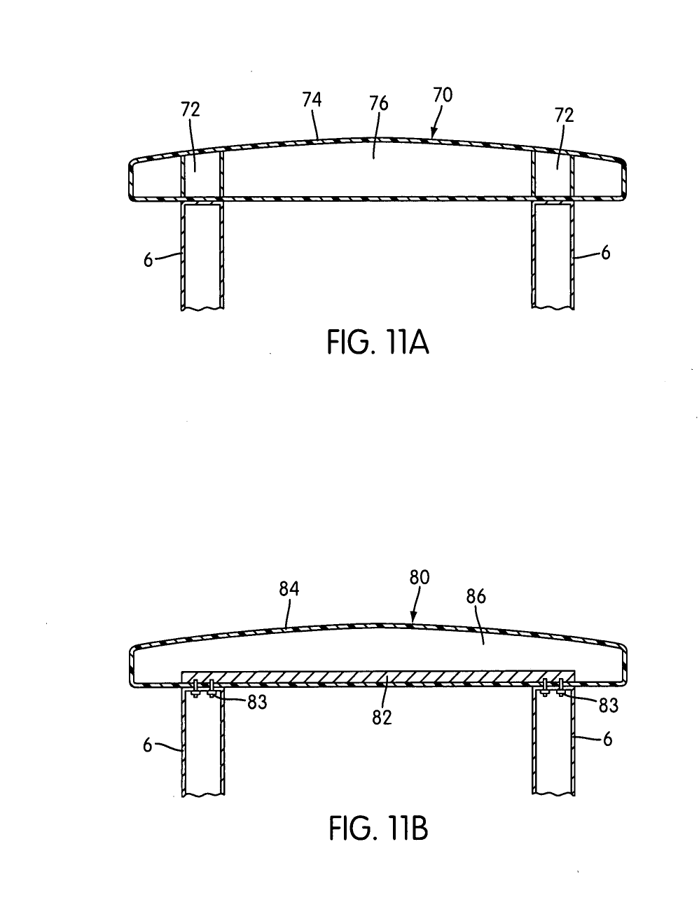

Other methods may also be used to form the bumper beam according to other exemplary embodiments. For example, according to one exemplary embodiment, the bumper beam may be formed in a process 60 in which a foam core is not provided prior to molding the bumper beam, as described with respect to FIG. 9.

In a first step 61, a mold is provided for use in forming the bumper beam. A first thermoplastic sheet is provided on one side of the mold and a second thermoplastic sheet is provided opposite of the first sheet in steps 62 and 63. The mold is then closed in a step 64 to join the sheets together to form the outer skin for the bumper beam. A foam precursor is injected into the mold between the first and second thermoplastic sheets in a step 65, after which the foam expands to fill a cavity between the sheets in the mold in a step 66. The mold is opened and the bumper beam is ejected from the mold in a step 67, after which any trimming/deflashing is performed on the bumper beam as may be required.

The composition and structure of this bumper beam permits a variety of design elements to be formed as part of or incorporated into the bumper system, including the insertion of reinforcements, crush cans, mounting brackets, and other components. Various features, such as guides, can also be formed into the outer skin to facilitate assembly of the bumper system. Attachments brackets can be inserted in between the sections of the outer skin and the core piece.

According to an exemplary embodiment shown in FIG. 11A, members or elements in the form of crush cans 72 for absorbing collision energy may be provided for a bumper beam 70. For example, the crush cans 72 shown in FIG. 11A are provided within the bumper beam 70 between the sections of the outer skin 74 and are surrounded by the foam core 76. The crush cans 72 are provided such that they are generally aligned with the frame rails 6 of the vehicle when the bumper beam 70 is mounted to the vehicle. Any suitable number of crush cans may be provided as part of the bumper beam in any suitable location, and may have a wide variety of sizes, shapes, and configurations according to various other exemplary embodiments. The crush cans may be provided within the mold during the formation of the bumper beam or may be provided after the bumper beam is formed (e.g., by either forming or molding one or more holes in the bumper beam initially or by cutting such holes in the bumper beam after the beam is formed, after which the crush cans may be inserted in the holes).

According to another exemplary embodiment shown in FIG. 11B, a bumper beam 80 having an outer skin 84 and a foam core 86 may have attached thereto (or provided as a component thereof) a member or element 82 in the form of a rail or bar that is formed of a metal such as steel, aluminum, or the like. According to other exemplary embodiments, the member 82 may be formed of other suitable materials (e.g., carbon fiber composites, etc.) that have the requisite physical characteristics (e.g., strength, flexibility, etc.).

The member 82 is provided to couple the bumper beam 80 to the frame rails 6 of the vehicle, and extends between the frame rails. Fasteners 83 (e.g., bolts, screws, etc.) are provided for coupling the bumper beam and/or the member 82 to the frame rails to secure the bumper beam to the vehicle. As illustrated in FIG. 11B, the member 82 is provided inside the bumper beam 80 between the foam core 86 and the skin 84 (e.g., the member is introduced during the molding process). According to other exemplary embodiments, the member 82 may be attached to an external surface of the bumper beam (e.g., between the skin 84 and the frame rails 6).

The member 82 is configured to provide additional resistance to bending and crushing of the bumper beam. According to various other exemplary embodiments, other reinforcing members such as plates, beams, angle irons, and other structural members may be coupled to the bumper beam (either within or outside the bumper beam).

Because the bumper beam is formed from a polymeric material, the configuration of the bumper beam may be relatively easily varied according to any of a variety of considerations (in contrast to roll formed bumper beams such as those shown in FIGS. 2 and 3, which must have a uniform cross-section along their length due to the manufacturing process used). For example, features intended to improve the local or overall strength of the beam may be added at desired locations. For example, as shown in FIG. 13, features or elements 90 in the form of ribs (e.g., protrusions, extensions, etc.) may be provided on an external surface of the bumper beam to add strength to the bumper beam. While FIG. 13 illustrates the ribs as extending away from an outer surface of the bumper beam and oriented longitudinally along the surface of the bumper beam, according to other exemplary embodiments, the ribs may extend away from an inner surface of the bumper beam (i.e., into the tubular bumper beam), may be provided on other surfaces, and/or may be provided in any size, shape, orientation, or configuration as may be desired. The ribs may be provided selectively at any desired location on the bumper beam (e.g., high stress areas) to provide localized resistance to deformation and may be optimized to allow for minimal material usage in manufacturing the bumper beam.

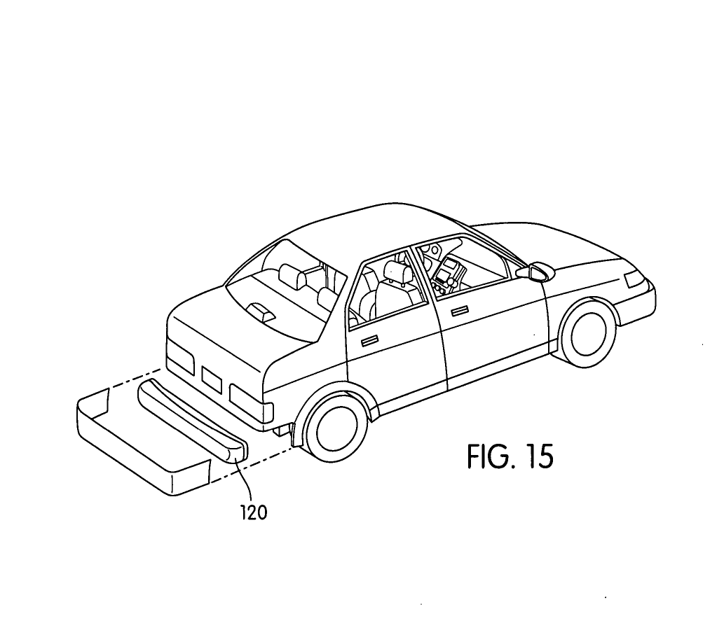

Other features may also be incorporated in the design of the bumper beams according to various other exemplary embodiments. For example, a number of solid or hollow members or cores in the form of cylinders 100 (shown in FIG. 14), hexagonal members 110 (shown in FIG. 15 in the form of a honeycomb configuration), and the like may be provided within all or a portion of the bumper beam to provide added strength or crush resistance for the bumper beam. Such members or cores may be formed from any suitable material, including a polymeric material such as polypropylene, polyethylene, polycarbonate, and the like, or from a metal such as steel, aluminum, or other suitable materials.

Honeycomb (or other shaped) cores may also be used in conjunction with a foam material provided within the bumper beam. For example, a foam may be used as the primary core material and with smaller honeycomb sections placed where needed to absorb energy. According to an exemplary embodiment, a typical honeycomb core, such as the one shown in FIG. 15, would have an average compressive strength of between approximately 0.5 and 10 MPa. According to a particular exemplary embodiment, a honeycomb core is used that has a compressive strength of 0.6 MPa.

The size, shape, location and/or configuration of these members may be vary according to various exemplary embodiments. According to other exemplary embodiments, any of a variety of cross-sectional shapes for the members may be employed in the bumper beam to provide the desired rigidity, strength, and formability crashworthiness for the bumper beam (e.g., cross-sectional shapes such as ovals, octagons, squares, triangles, trapezoids, pentagons, and the like may be utilized for the members).

According to one exemplary embodiment, the bumper beam has a relatively uniform cross-sectional shape and composition from end to end. According to other exemplary embodiments, the bumper beam may have a variable cross-sectional shape from end to end. Again, because the process used to form the bumper beam allows for enhanced flexibility as compared to the roll formed bumper beams as shown in FIGS. 2 and 3, any suitable design may be used for the bumper beam.

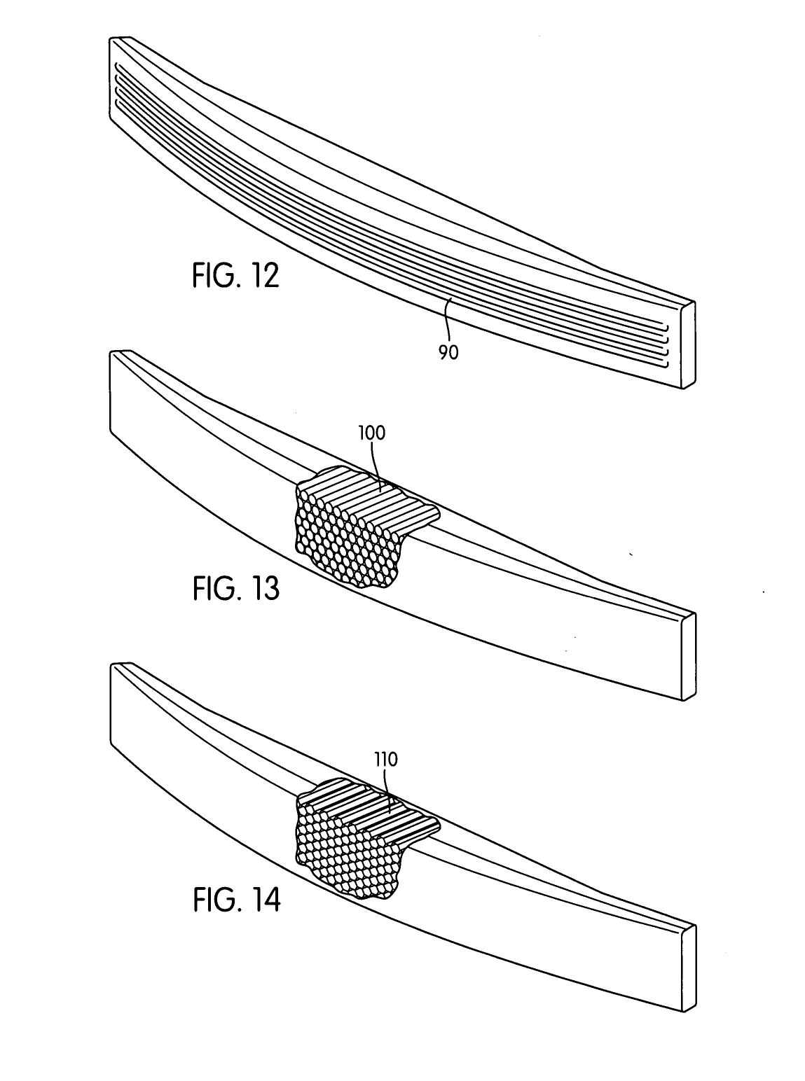

One advantageous feature of the flexibility that may be realized in designing the bumper beam is that features may be integrated within the bumper beam that may eliminate the necessity to have a separate energy absorber coupled to the bumper beam. As shown in FIG. 15, a bumper assembly 120 may be provided that includes features of both a bumper beam and an energy absorber. Features such as crush cans and other features as described with respect to FIGS. 11A-14 may be included in the bumper beam to provide enhanced strength and absorption characteristics as may be appropriate for a given design. Various features that are included in known energy absorbers may be incorporated into the design in this regard. Any suitable method now known or hereafter developed may be used to form the bumper beam/energy absorber part. For example, an energy absorber component may be formed using any suitable technique (e.g., injection molding, blow molding, etc.), after which the energy absorber component may be introduced into a mold along with one or more skin portions. The foam core may be introduced in situ or may be provided as a separately formed piece that is placed in the mold prior to forming the final part.

According to an exemplary embodiment, the ends of the bumper beam are open such that the foam material provided as the core is exposed at the ends of the bumper beam. According to other exemplary embodiments, the foam material may be concealed on the ends of the bumper beam by providing caps or covers for the ends of the bumper beam (or by molding the beam in a manner such that the skin material is folded over and joined at the ends of the bumper beam to conceal the internal core materials).

It should be noted that references to relative positions (e.g., “top” and “bottom”) in this description are merely used to identify various elements as are oriented in the FIGURES. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the bumper beam as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied (e.g., the position of a reinforcing member), and the nature or number of discrete elements or positions may be altered or varied. The order or sequence of any process or method steps may be varied or re-sequenced according to other exemplary embodiments. Other substitutions, modifications, changes and omissions may be made in the design, operating conditions and arrangement of the various exemplary embodiments without departing from the scope of the present inventions as expressed in the appended claims.

What is claimed is:

1. A bumper beam for a vehicle comprising:
an outer skin formed of a polymeric material; and
a core provided within the outer skin, at least a portion of the core comprising an expanded material;
wherein the bumper beam is configured for coupling to a vehicle and the outer skin and core are configured to resist deformation in a vehicle collision.

2. The bumper beam as recited in claim 1, wherein the outer skin comprises a reinforced thermoplastic material.

3. The bumper beam as recited in claim 2, wherein the outer skin comprises a plurality of fibers provided within a matrix of thermoplastic material.

4. The bumper beam as recited in claim 3, wherein the plurality of fibers are selected from the group consisting of glass fibers, carbon fibers, nylon fibers, and combinations thereof.

5. The bumper beam as recited in claim 3, wherein the plurality of fibers have average lengths greater than approximately 25 millimeters.

6. The bumper beam as recited in claim 2, wherein the outer skin comprises a mat of fibers provided within a matrix of thermoplastic material.

7. The bumper beam as recited in claim 1, wherein the polymeric material comprises at least one material selected from the group consisting of polypropylene and polyethylene.

8. The bumper beam as recited in claim 1, wherein the core comprises a foam material selected from the group consisting of polypropylene, polyurethane, polystyrene, and derivatives and combinations thereof.

9. The bumper beam as recited in claim 1, wherein the expanded material has an average compressive strength of between approximately 0.3 and 1.5 MPa.

10. The bumper beam as recited in claim 1, wherein the core further comprises at least one crush can.

11. The bumper beam as recited in claim 1, wherein the core further comprises at least one tubular member configured to provide enhanced crush resistance for the bumper beam.

12. The bumper beam as recited in claim 1, wherein the core comprises a plurality of tubular members configured to provide enhanced crush resistance for the bumper beam.

13. The bumper beam as recited in claim 1, further comprising a metal member coupled to the bumper beam for provided enhanced strength for the bumper beam.

14. The bumper beam as recited in claim 13, wherein the metal member is configured for coupling the bumper beam to a frame of a vehicle.

15. The bumper beam as recited in claim 1, wherein the outer skin comprises a first sheet of material coupled to a second sheet of material.

16. The bumper beam as recited in claim 15, wherein the first sheet of material and the second sheet of material are formed of different materials.

17. The bumper beam as recited in claim 1, wherein the outer skin comprises a plurality of sheets of polymeric material coupled together such that the outer skin comprises a plurality of layers of material.

18. The bumper beam as recited in claim 1, wherein the outer skin comprises a plurality of ribs for providing enhanced rigidity for the bumper beam.

19. A polymeric bumper beam for use in vehicle applications comprising:
a shell formed of a reinforced thermoplastic material; and
an interior portion comprising an expanded foam material;
wherein the bumper beam is configured for attachment to a vehicle.

20. The polymeric bumper beam as recited in claim 19, wherein the reinforced thermoplastic material comprises a polymeric matrix comprising a material selected from the group consisting of polypropylene and polyethylene.

21. The polymeric bumper beam as recited in claim 20, wherein the reinforced thermoplastic material comprises a plurality of fibers, wherein at least a portion of the plurality of fibers comprise a material selected from the group consisting of glass, carbon, and nylon.

22. The bumper beam as recited in claim 21, wherein the plurality of fibers have average lengths greater than approximately 25 millimeters.

23. The polymeric bumper beam as recited in claim 19, wherein the expanded foam material is selected from the group consisting of polypropylene, polyurethane, polystyrene, and derivatives and combinations thereof.

24. The polymeric bumper beam as recited in claim 19, wherein the expanded foam material has an average compressive strength of between approximately 0.3 and 1.5 MPa.

25. The polymeric bumper beam as recited in claim 19, wherein the interior portion further comprises at least one member selected from a crush can, a group of hollow tubular members, and a metal member.

26. The polymeric bumper beam as recited in claim 25, wherein the interior portion comprises a metal member that is coupled to the shell to provide enhanced strength for the bumper beam.

27. The polymeric bumper beam as recited in claim 19, wherein the shell comprises a plurality of ribs for providing enhanced rigidity for the bumper beam.

28. The polymeric bumper beam as recited in claim 27, wherein the plurality of ribs are oriented longitudinally along the length of the bumper beam.

29. A vehicle bumper beam comprising:
a tubular member comprising a polymeric matrix and a reinforcing material provided within the polymeric matrix; and
a material provided within at least a portion of the tubular member that is configured to provide compressive strength for the bumper beam;
wherein the bumper beam is configured for attachment to a vehicle and to an energy absorber for a vehicle bumper system.

30. The vehicle bumper beam as recited in claim 29, wherein the tubular member comprises at least one sheet of material that includes a polymeric matrix comprising a material selected from the group consisting of polypropylene and polyethylene.

31. The vehicle bumper beam as recited in claim 30, wherein the at least one sheet of material comprises a plurality of fibers, wherein at least a portion of the plurality of fibers comprise a material selected from the group consisting of glass, carbon, and nylon.

32. The vehicle bumper beam as recited in claim 31, wherein the plurality of fibers have average lengths greater than approximately 25 millimeters.

33. The vehicle bumper beam as recited in claim 29, wherein the material provided within at least a portion of the tubular member is a foam material selected from the group consisting of expanded polypropylene, polyurethane, polystyrene, and derivatives and combinations thereof.

34. The vehicle bumper beam as recited in claim 29, wherein the foam material has an average compressive strength of between approximately 0.3 and 1.5 MPa.

35. The vehicle bumper beam as recited in claim 29, further comprising at least one crush can provided within the tubular member.

36. The vehicle bumper beam as recited in claim 29, further comprising an array of members provided within the tubular member that are configured to provide enhanced strength for the bumper beam.

37. The vehicle bumper beam as recited in claim 29, further comprising a member coupled to the tubular member for providing enhanced strength for the bumper beam.

38. The vehicle bumper beam as recited in claim 37, wherein the member comprises a metal material.

39. The vehicle bumper beam as recited in claim 27, further comprising a plurality of ribs extending from the tubular member.
